(19) United States
(12) Patent Application Publication
(10) Pub. No.: US 2023/0158510 A1
(43) Pub. Date: May 25, 2023

(54) METHOD OF MONITORING HIGH-PRESSURE ROLLER PRESS

(71) Applicant: MASCHINENFABRIK KÖPPEREN GMBH &CO.KG, Hattingen (DE)

(72) Inventors: Max BUCHMEIER, Wuppertal (DE); Eggert DE WELDIGE, Velbert Langenberg (DE)

(21) Appl. No.: 17/919,949

(22) PCT Filed: Mar. 30, 2021
(86) PCT No.: PCT/EP2021/058350

§ 371 Date: Oct. 19, 2022

(30) Foreign Application Priority Data
Apr. 6, 2020 (DE) 102020114835.6

(51) Int. Cl. B02C 4/32; B02C 4/02

(52) U.S. Cl. CPC B02C 4/32; B02C 4/02; B02C 2210/01

(57) ABSTRACT

The invention relates to a method for monitoring the wear state of the rolling surfaces of a high-pressure roller press in the course of comminuting, compacting, or briquetting material. The roller press has two rotationally driven press rollers, between which a rolling gap is formed with a gap width that can be modified during operation. One of the press rollers is designed as a stationary roller, and one of the press rollers is designed as a loose roller, wherein the loose roller can be positioned against the stationary roller via a force generating means with a gap width which can be modified during operation, and the outer diameter of the press rollers or the is reduced due to wear during operation. The method is characterized in that the position of the loose roller is recorded as a function of time using at least one position sensor, the position data is stored on a computer, and the wear state of the rollers is ascertained from the measured position data using an algorithm.

The invention relates to a method of monitoring the state of wear of the roll surfaces of a high-pressure roller press when comminuting, compacting or briquetting material, wherein

the roller press has two rotatably driven press rolls (working rolls) forming a roll gap whose gap width is variable during operation,

one of the press rolls is a fixed roll and one of the press rolls is a movable roll and the movable roll is adjusted relative to the fixed roll by an actuator with a gap width that is variable during operation, and the outer diameter of the rolls decreases by wear during operation.

The press rolls can for example each have a roll core and a jacket on the roll core whose outer diameter decreases during operation by wear. In such an embodiment, the roll surfaces that are subject to wear are consequently formed by the jackets.

A high-pressure roller press for comminuting material is also referred to as a material bed roll mill. However, the invention also relates to high-pressure roller presses for compacting or briquetting material. The material is in particular highly abrasive material, for example ore, cement clinker, slag or ceramic base materials. The roller press can also be used for compacting for example fertilizers. One of the press rolls is preferably a fixed roll and is consequently rotatably mounted in a press frame in a stationary manner. At least one press roll is a movable roll, i.e. it is adjusted relative to the other roll, for example the fixed roll, by an actuator, for example by hydraulic cylinders, with a variable gap width during operation. The two press rolls are driven in opposite directions (synchronously) via drives. The gap between the rolls—as a result of the described positioning of the movable roll against the fixed roll—sets up until a pressure corresponding to the setting forces acts between the rolls. The gap width results from the ratio of the setting forces to the reaction forces originating from the material to be processed. Each press roll preferably has a rotatably driven roll core and a jacket fastened to the roll core and forming the (wear-resistant) roll surface of the roll. The jacket can be a completely circumferential (one-piece) ring or alternatively can be formed by a plurality of segments fastened to the core. Alternatively, rolls in the embodiment can also be used as solid rolls or segmented rolls having corresponding roll surfaces.

In practice, it is customary to monitor, control and optionally display the state or operating condition of a high-pressure roller press continuously or quasi-continuously. For this purpose, the roller press is provided with measured value pick-ups that receive various operating data of the roller press, which can be stored in the prior art for example on a computer and/or displayed in a control room of the plant. Thus for example the torque of the press rolls, the hydraulic pressures in the cylinders of the movable roll and the gap width are measured with suitable detectors or sensors in turn connected for example to a controller, for example a programmable logic controller (SPS) that in turn is connected to a control room of the system or to a computer arranged in the control room.

A high-pressure roller press for a material bed is known from DE 101 06 856 in which, during operation, the drive and movement parameters of at least one roll are measured as control parameters and the ratio of these values to one another is formed and this ratio is always kept substantially constant by reducing or increasing the roller pressing force of the rolls. For this purpose, for example in operation, the drive power of a main motor and the circumferential speed of the rolls are measured and the ratio of this is used as a controlled variable.

DE 42 26 182 describes a high-pressure roller press in which the bearing blocks of the movable roll are braced against hydraulic cylinders of a hydropneumatic system and sensors are provided for measuring the width of the roll gap that is established at the two roll sides during operation. The sensors, measure the distance between the bearing blocks of the two rolls and the signals obtained are fed via lines to the inputs of a monitoring and controller. The spacing between the bearing blocks that is created during operation of the machine and thus also the width of the roll gap occurring during operation at both roll sides is measured continuously or temporally in a clocked manner by the sensors, and the difference between the two measured values is calculated and compared with a predetermined tolerance value. If, in the case of an unsymmetrical load of the roll gap, for example, the bearing block of the movable roll moves inward into an angled position of the movable roll exceeding the predetermined tolerance value, a control intervention takes place via the central monitoring and controller, specifically in this case relating to the loading of the roll gap by adjusting actuating motors for metering flaps on the feed shaft.

Monitoring the operating state of rotating rolls in an industrial plant is also described, for example, in WO 2007/025395 specifically for mills for grain processing. In this case, vibrations are monitored and therefrom a time-variable electrical signal is generated that is subjected to frequency analysis. The vibrations can be detected, for example, by an accelerometer mounted on the bearing of the rotating roller. The analysis can be carried out with a computer that can also be integrated into a control system of an automated industrial plant and that can also have monitoring screens for displaying for example the operating state. The industrial plant can also have a plurality of rotating rolls and a plurality of systems that are networked to one another and to a monitoring center, for example wirelessly cross-linked.

DE 20 201 5 106 156 discloses a roller mill with counter-rotating rolls, one of which is displaceable orthogonally to the axial direction of this roller. The roller mill has a sensor that measures a spacing to a grinding surface of the roller to be measured during operation of the roller mill.

WO 2018/036978 [U.S. Pat. No. 11,065,626] describes a self-optimizing, adaptive production-processing system having a grinding system that includes a roller press and at least one sensor for detecting measured values relating to a state of at least one roll, so that measured values that characterize a state of the roller are detected. Measured values relating to at least one roll are received from a data transmitter by a data receiver of a controller of the production-processing system. In this case, the roll operation and the width of the gap between the rolls and/or the parallelism of the rolls are automatically optimized by the controller with or without feedback and connected to the controller on the basis of the received measured values.

DE 10 200 7 004 004 discloses a roller mill having a monitoring device that checks the state of wear of the pin-shaped profile bodies and that, in addition to the wear state of the profile bodies, also checks the state of the autogenous wear protection layer and determines the presence or absence of the profiled bodies. For this purpose, a sensor can be provided so as to be movable relative to the grinding roller.

Monitoring the operating state of machines is also described, for example, in WO 2017/197449 [US 2019/0187679] where a plurality of parameters of the machine are measured and the thus measured values are made available, normalized indicator values are generated from these measured values and these standardized indicator values are used for describing the state of the machine. In this case, machine modules corresponding to individual machines can be assigned that are each equipped with a computer. The individual machine modules can be connected to a common plant module via a network. Moreover, machine modules of different installations can also be connected directly to a central monitoring system that collects sensor data of a plurality of machine modules of a plurality of installations that may optionally also be geographically distributed, so that methods of the “Internet of Things” are resorted to.

Overall, there is a need in machine and plant technology to monitor and display the state of machines. In practice, this takes place in connection with high-pressure roller presses as a rule via the detection of the sensor data by conventional memories of programmable controls connected to a control room of the installation.

Moreover, so-called superordinate solutions are known in which operating data of machines are stored centrally for example in the cloud and are optionally evaluated so that the data can be accessed via the Internet with different terminals, for example laptops, tablets or smart phones.

Proceeding from the known prior art, the object of the invention is to provide, in connection with high-pressure rolls intended for the comminution, compaction or briquetting of material, a method that allows a simple, reliable and dependable monitoring of the wear state of the rolls surfaces of a high-pressure roller press (for example the jackets thereof).

In order to achieve this object, the invention relates to a generic method of monitoring the wear state of the roller surfaces of the type described above where

the position of the movable roller is recorded as a function of time with at least one position sensor and the position data are stored on a computer, and

the wear state of the roller surfaces is determined using an algorithm from the measured position data.

An algorithm from the measured position data, is used in particular to generate a prediction for the remaining service life of the rolls.

Monitoring the gap width of the roll gap with position sensors is basically known from practice. During operation, the nip is continuously adjusted by the hydraulic cylinders and adjusted to be kept constant throughout operation. Thus, on the basis of the data collected up to now, it is not possible to determine the wear state of the rolls or of the roll surfaces thereof, because even if the diameters of the working rolls decrease due to wear, the roll gap is kept substantially constant by the hydraulic adjustment. According to the invention, it is now proposed to determine the position of the movable roll absolutely or as an absolute measurement, i.e. the position of the movable roll relative to a stationary reference system, for example to the press frame, is measured and stored. The position sensors can preferably detect the position of the bearing points of the movable rolls, preferably both bearing points of the movable roll. While the gap width should not change or change over time during operation, the wear of the roll surface, for example of the outer surface or jacket, can be determined very easily on the basis of the changing position of the movable roll. This is because with increasing wear of the roll surface and consequently with decreasing roll diameter, the movable roll moves away from that of the fixed roll, so that the position of the bearing points of the movable roll always approaches the position of the bearing points of the fixed roll. The average temporal position of the bearing points of the movable roll are consequently a good measure of the decrease in the roll diameter and thus for the wear state of the rolling surfaces, for example of the jackets. With the aid of an algorithm, a prediction for the remaining service life of the rolling surface, for example of the jacket, can be generated on the basis of data or empirical values previously made available. In this way, maintenance predictions (“predictive maintenance”) can be created with the invention.

The position of the bearing points can be measured directly with the aid of position detectors or sensors that are mounted at the bearing points of the movable roll. However, the measurement of the position of one or more bearing points can also be carried out with the aid of sensors that are not directly at the bearing points but spaced therefrom and that for example detect the position of a measuring point or a measuring surface that is connected to the bearing points or whose position correlates with the position of the bearing points. Alternatively, it is also possible to measure the position of the (rotating) roll journals in order to determine the position of the movable roll, for example by engagement via sliding contacts or in a contactless manner, for example with optical sensors or also contact-free sensors of a different design. The change in the position of the movable roll is always determined and from the position data the wear state of the roll or of the their roll surfaces are determined.

The method according to the invention can be realized in principle with conventional hardware, since in known installations the roller press or its position sensors is connected for example via a control system, preferably a (PLC) controller that can be programmed in a control room of the system and consequently is connected to a computer in the control room. Storage of the absolute position and the determination of the wear state from the position data can consequently take place in a first embodiment with a computer, for example in the control room of the plant, taking into account the data transmitted via the PLC.

In a second, preferred embodiment, the position sensors are connected alternatively or in addition to the conventional PLC with an edge computer as an analysis computer. For this purpose, the position data are (initially) stored as raw data on an edge computer on or adjacent the roller press and connected to the sensors as an analysis computer, and the raw data are evaluated on the analysis computer with an analysis algorithm and thus characteristic data for the wear state and these characteristic data are stored on the analysis computer and the characteristic data are transmitted from the analysis computer to at least one terminal via a wireless network (wirelessly) and displayed on the terminal, for example.

In this context, the invention is based on the discovery that it is advantageous to first store the operating data determined with the sensors (for example position sensors) as raw data on a powerful edge computer that is arranged in the immediate vicinity of the roller press and is particularly preferably connected to the sensors in a cable-bound manner. However, this edge computer not only serves to store the operating data as raw data, since the analysis or evaluation of the raw data is carried out with corresponding algorithms directly stored on the edge computer. In this embodiment, storage of the operating data or raw data in a superordinate system, for example in the cloud, is also dispensed with, as is the transmission of the raw data via a data network or the Internet. Rather, an analysis with suitable algorithms is already carried out locally and storage of the (compressed) characteristic data generated from these raw data with the aid of the algorithms, which data can be collected for example in a database on the analysis computer and can be made available there (for example for retrieval by a terminal). In this case, in principle known and available hardware can be resorted to, that is to say powerful edge computers with considerable memory and powerful processors can be used and the basic strengths of “edge computing” known in principle can be exploited.

For determining and storing the position data, known sensors can be used, for example position sensors or travel sensors at the bearing points of the movable roll. In addition, further measured values can be recorded for information with basically known sensors. This may be torque detectors or torque sensors for the rolls, pressure sensors for the hydraulic pressure of the cylinders, flow sensors, temperature sensors or the like. The sensors can provide analog measurement values, for example as current signals that are converted into digital data via a suitable device, for example via a converter, so that digital raw data are stored on the edge computer. The processing and analysis of the raw data may be performed on the local analysis computer (edge computer). As an alternative to these sensors that generate analog measured values, it is also possible to use sensors with a digital output that output the signal for example as an encoded pulse sequence.

The characteristic data of the roller press generated on the edge computer by applying the stored algorithms can be retrieved online via a wireless network, for example via the Internet, or can be transmitted wirelessly to terminals via the wireless network. The terminals can be for example external PCs, notebooks, tablets or smartphones. It is self-evident that access to the characteristic data for the purpose of information or display on the terminal is possible only by appropriate access authorization. In a preferred embodiment, the edge computer is connected to a router, for example a commercial-grade router, via which a connection to a wireless network, for example to the Internet, is established, so that online access to the characteristic data stored in the database on the edge computer is possible. In a preferred development, retrieval or access is not carried out directly via the commercial-grade router, but via an external portal that is connected wirelessly, for example via a VPN connection (virtual private network) to the commercial-grade router. It is thus possible for example to access the portal via suitable terminals with an https connection and from there (via VPN) get access to the characteristic data via the commercial-grade router. Optionally, there is also the possibility for example of connecting a computer for remote maintenance via a VPN network to the portal. Via simple https connections, there is generally only the possibility of retrieving the characteristic data and consequently displaying information on the terminal via simple https connections. Via the VPN connection, it is possible for example to access the edge computer in the sense of remote maintenance. It goes without saying that access rights corresponding to the portal and for the terminals are assigned and the comprehensibility of the accesses is registered by protocols.

The characteristic data can contemporaneously represent the for example directly determined concrete data regarding roll position and can be displayed. Alternatively or additionally, statistical evaluation be used as characteristic data, for example, machine conditions based on weekly or monthly time frames.

In a particularly prefer embodiment the characteristic data is not simply machine information or processed or compressed measurement data that is related directly to the output of a sensor (for example load, gap width, or the like) but particularly preferably are made virtual to determine and show for example critical conditions. This relates particularly to the wear condition and a remaining service life.

The operating data and consequently the raw data are preferably recorded at a high sampling rate of more than 50 Hz, for example more than 100 Hz, preferably at least 200 Hz and stored on the analysis computer. The invention is based on the recognition that the programmable controllers (SPS) that are usually used in practice and that are connected to the sensors, as a rule can not provide, process, and store the measurement data at high speed or a high sampling rate. Optionally, the data are forwarded by the sensors for example without an interposed PLC directly to the edge computer or to an evaluation unit that is connected to the edge computer or integrated into the edge computer and suitable for recording and storing the operating data at the high sampling rate. 50 Hz means that 50 measured values per second (i.e. a measured value of 20 ms) is made available. The invention has recognized that certain operating states, interference states or critical states can be determined only when the operating data are made available at a correspondingly high sampling rate. This results in large amounts of data. However, since these are stored locally and in a hard-wired environment to the edge computer directly on site, these quantities of data can be handled without problems. Access via a (wireless) network is not necessary for this large amount of raw data, since the large amounts of data are initially compressed by suitable evaluations on the edge computer, so that the user only has to access the compressed or evaluated data via a wireless network.

According to the invention, optimization of the processes is achieved under the point of view of the “Industry 4.0” or

“Internet of Things”. The roller press can be extended to a “talking machine.” In this case, programmed algorithms are optionally resorted to, and algorithms or methods of artificial intelligence (AI) and consequently self-learning or self-optimizing algorithms can optionally also be used.

The subject matter of the invention is not only the described method, but also an installation for comminuting, compacting or briquetting material according to claim 6. Consequently, the range of the invention covers not only the method but also the system with a computer, where for example a computer is provided with an edge computer of the type described, and this computer or edge computer is provided with corresponding programs for the data processing and/or algorithms that are set up to carry out the described method.

The invention is explained in more detail below with reference to drawings showing embodiments by way of example. Therein:

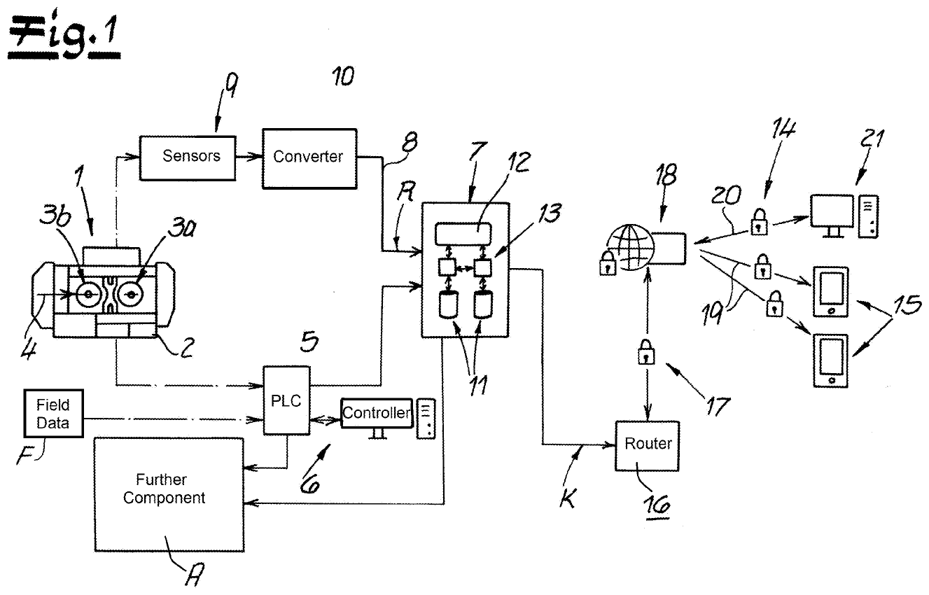

FIG. 1 is a schematic greatly simplified diagram of a system according to the invention with a roller press,

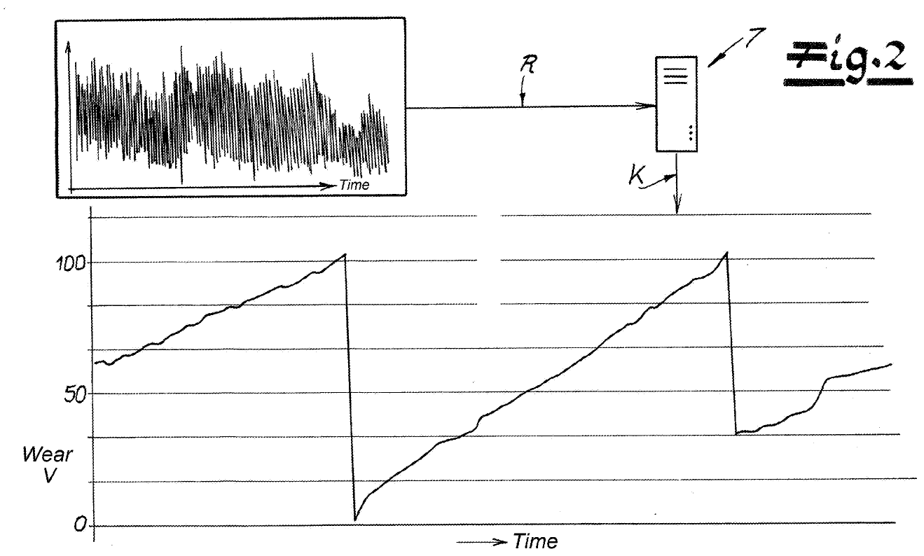

FIG. 2 is a view of the movable roll position and the wear state for maintenance prediction.

FIG. 1 shows, for example, a system for monitoring a condition of a high-pressure roller press 1 is intended, for example, for comminuting granular material, alternatively also for compacting or briquetting material. The roller press has a press frame 2 and two press rolls 3a and 3b that are rotatably mounted in the press frame 2 and are driven for rotation in opposite directions. A roll gap whose gap width is variable during operation is formed between the press rolls. This is because one of the two press rolls is designed as a fixed roll 3a mounted in a stationary manner in the press frame 2, and the other press roll is designed as a movable roll 3b, and this movable roll can be urged toward the fixed roll 3a via biasing means, for example via hydraulic cylinders 4, so that the gap width of the roll gap can change during operation. However, the roll gap is adjusted automatically during operation due to the positioning of the movable roll with respect to the fixed roll until a certain pressure is exerted between the rolls. Each of the two press rolls 3a and 3b has a roll surface that is subject to wear. In one embodiment, each roll 3a and 3b can have on the one hand a driven roll core and on the other hand a jacket (for instance tubular) on the roll core, which jacket, for example, is provided with a wear-resistant surface. Details are not shown in the figures.

Such a roller press 1 can be connected in a conventional manner to a programmable logic controller or PLC 5 that in turn can be connected to a higher-level plant controller or control room 6. The operation of the roller press 1 can be controlled and monitored in a known manner via the guide plate 6. For this purpose, the PLC 5 can be connected on the one hand to the drives of the roller press and on the other hand to different sensors.

In this embodiment, however, as an alternative or in addition to the programmable logic controller 5, a special computer is provided, namely an edge computer as an analysis computer 7 that is hard wired via one or more connecting cables 8 to sensors 9 of the roller press. This edge computer or analysis computer 7 is locally stationary in the immediate vicinity of the roller press. Operating data registered by the sensors 9 are stored as raw data on this analysis computer 7. For this purpose, the sensors 9 may be provided with (additional) measuring devices or cards 10, with which the analog measurement data are converted into digital operating data R. Preferably, optical connecting cables, for example optical waveguides for particularly fast data transmission for the connection 8 of the measuring card 10 to the analysis computer 7, are used. The analysis computer 7 is provided as an edge computer with considerable memory 11, processors 12 and specially designed algorithms 13 for the analysis and evaluation of the operating data. Several memories 11 for redundant data storage are preferably provided in the analysis computer 7. The raw data R are stored on the analysis computer 7 and evaluated with the analysis algorithms 13 and thus characteristic data K of the roller press 1 are generated that are likewise stored on the analysis computer. According to the invention, these characteristic data K are transmitted from the analysis computer 7 via a wireless network 14, for example via the Internet, to one or more terminals 15, for example PCs, tablets, smart phones or the like. The characteristic data K can be accessed via the terminals 15. It is of particular importance here that correspondingly authorized users have access to the already evaluated characteristic data K via the terminals 15 and not to the very extensive raw data. For this purpose, the characteristic data K in the analysis computer 7 can be stored in the analysis computer 7 for example in a database as compressed data and provided in the database for online access via PC, smart phone or the like, for example for corresponding plant status displays.

In this case, the operating data R can be recorded in a conventional manner with known measuring value sensors 9 provided in any case at the roller press. According to the invention, the position of the movable roll is detected for example by position sensors for wear monitoring. In addition, further data can be determined by further sensors, namely for example the torque of a press roll or of both press rolls, the hydraulic pressure of the hydraulic cylinders for the application of the movable roll, weighing cells, temperature sensors, flow sensors or the like. The state of the roller press 1 or values of these sensors 9 can be displayed in compressed form via the terminals 15 in a simple manner, so that current machine status can be displayed. Alternatively, statistical evaluations can be queried on the terminal 15 that, however, are not generated on the terminal 15, but rather on the analysis computer 7, for example individual week reports, month reports or the like. Particularly preferably, however, interference conditions, exceptional conditions or the like can be monitored using the method according to the invention.

For this purpose, it is particularly advantageous if the operating data are recorded as raw data R at a high sampling rate of more than 100 Hz, for example more than 200 Hz and stored on the analysis computer 7. This results in extremely large amounts of data that, however, are transmitted via hard wiring directly to the local analysis computer 7 and stored there and already evaluated. From the very large quantities of data, the desired characteristic data or characteristic values K are generated by the already mentioned analysis algorithms 13 and can be accessed by the terminals 15 via the wireless network 14, for example via the Internet.

FIG. 1 shows that the computer 7 is connected for online access to a commercial-grade router 16 that, in a preferred variant, is connected to an Internet portal 18 via a VPN network or VPN connection 17. The terminals 15 consequently do not access the commercial-grade router 16 directly for a query of the evaluated characteristic data, but via the portal 18, specifically for example via secured or encrypted https connections 19. Otherwise, an additional computer or PC 21 can optionally be connected to the portal 18 via an additional VPN connection 20, so that data is not only queried via this PC for remote maintenance, but can also be accessed on the analysis computer 7 or the roller press.

It is furthermore indicated in FIG. 1 that field data F and consequently data from other components of the plant, for example a grinding system A, can also be detected at the PLC 5 and/or the computer 7, for example operating data of a sifter.

Finally, data, commands or the like can also be transmitted from the analysis computer 7 to the roller press 1 or other components of the system. For example, the evaluated characteristic data can be used for controlling the press or other machines with or without feedback.

The method according to the invention is illustrated for example with reference to FIG. 2 that shows the position of the movable roll 3b (top left) as a function of time. The absolute position of the movable roll 3b is detected by one or more position sensors. The position of the movable roll 3b relative to a stationary press frame 2 is referred to as the position of the movable roll 3b. For this purpose, position sensors 9 can be mounted at the bearing points of the movable roll, for example. In FIG. 2 the position of a bearing point as a function of time is shown at the top left. It can be seen that these raw data R are first picked up at high frequency and stored on the analysis computer 7. The latter generates therefrom the characteristic data K that are plotted in the graph at the bottom. This is a measure of the wear V of the rolling surfaces, for example of the jackets, and it can be seen that this measure increases with increasing operating time, since the working roll diameter, for example the diameter of the jacket decreases as a result of wear. If a certain upper limit value is reached, the rolling or rolling surfaces, for example the jackets, are exchanged. This can be seen by the abrupt drop at the points shown. While the raw data R actually relate to the position data, the characteristic data K are data that represent the wear state V of the rolling surface. According to the invention, there is the possibility of displaying the wear state that is plotted in FIG. 2, on the terminals 15.

Alternatively or additionally, maintenance predictions can also be made, i.e. a time at which an exchange of the rolling surface or of the rolls is required or recommended can be displayed on the terminal.

1. A method of monitoring a wear state of roll surfaces of a high-pressure roller press in the course of comminuting, compacting or briquetting material, where
the roller press has two rotatably driven press rolls forming a roll gap whose gap width is variable during operation,
one of the press rolls is a fixed roll and one of the press rolls is a movable roll and the movable roll can be adjusted relative to the fixed roll by an actuator with a variable gap width during operation, and
an outer diameter of the press rolls or rolling surfaces thereof decrease during operation by wear, the method comprising the steps of:
recording the position of the movable roll is as a function of time with at least one position sensor position data are stored on a computer, and
determining the wear state of the roll or of the rolls or rolling surfaces thereof using an algorithm from the measured position data.

2. The method according to claim 1, further comprising the step of:
generating a prediction for a remaining service life of the roll or roll surface with an algorithm from the measured position data.

3. The method according to claim 1, further comprising the step of:
measuring the position of one or more bearing points of the movable roll with one or more position sensors relative to a stationary press frame and generating position data representing the measured position.

4. The method according to claim 1, further comprising the steps of:
storing the position data as raw data on an edge computer on or adjacent the roller press and connected to the sensors as an analysis computer,
evaluating the raw data are evaluated on the analysis computer with an analysis algorithm and thus generating characteristic data for the wear state and storing these characteristic data are stored on the analysis computer,
transmitting the characteristic data from the analysis computer to at least one terminal via a wireless network and displaying or further the characteristic data on the terminal.

5. The method according to claim 1, further comprising the step of:
recording the raw data at a high sampling rate of more than 50 Hz and
storing the raw data on the analysis computer.

6. A plant for comminuting, compacting or briquetting material according to a method according to claim 1, comprising at least
a roller press having two rotatably driven press rolls, forming a roll gap whose gap width is variable during operation, one of the press rolls being a fixed roll and one of the press rolls being a movable roll and the movable roll being adjustable relative to the fixed roll by an actuator with a variable gap width during operation,
one or more position sensors that can record position data of the movable roll as a function of time and store the position data d on a computer,
means for determining the wear state of the roll/rolls or the roll surfaces thereof using an algorithm from the measured data and generating a prediction for a remaining service life of the jacket.

7. An installation according to claim 6, further comprising:
an edge computer located locally at the roller press and connected to the position sensors as an analysis computer.

8. The installation according to claim 6, further comprising
an analysis router connected to the computer and a terminal accessed via the router at a portal connected to the router via a VPN connection.

9. The installation according to claim 6, wherein the press rolls each have a roll core and a jacket on the roll core and forming a roll outer surface.
